(19) United States
(12) Patent Application Publication
(10) Pub. No.: US 2017/0291589 A1
(43) Pub. Date: Oct. 12, 2017

(54) Electronically Slip-Controlled Vehicle Brake System

(71) Applicant: Robert Bosch GmbH, Stuttgart (DE)

(72) Inventor: Wolfgang Schuller, Cleebronn (DE)

(21) Appl. No.: 15/516,801

(22) PCT Filed: Aug. 6, 2015
(86) PCT No.: PCT/EP2015/068130

§ 371 Date: Apr. 4, 2017

(30) Foreign Application Priority Data
Oct. 9, 2014 (DE) 10 2014 220 542.5

(51) Int. Cl. B60T 13/68; B60T 8/48; B60T 17/02; B60T 8/40

(52) U.S. Cl. CPC B60T 13/686; B60T 8/4059; B60T 8/4872; B60T 17/02

(57) ABSTRACT

A hydraulic vehicle brake system includes at least one brake circuit, at least one wheel brake, and a pressure-generating unit. The pressure-generating unit is configured to supply the wheel brake with pressure medium under brake pressure, or to adapt the brake pressure to slip conditions of a wheel assigned to the wheel brake. A feed volume of the pressure medium of the pressure-generating unit is controllable according to a pressure medium volume demand. The pressure-generating unit includes at least two pumps that feed into a common pressure line, and an electronically actuated mechanism configured to control a pressure medium connection from the pressure line and a suction side of at least one of the pumps as a function of the demand.

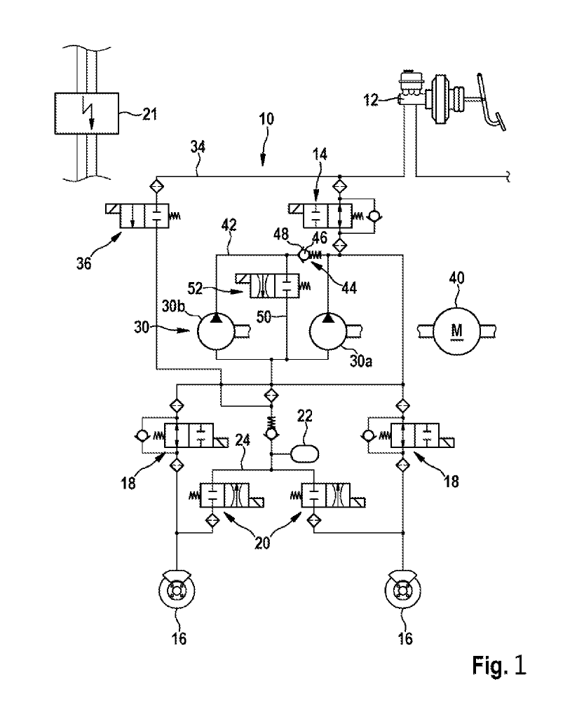

### PRIOR ART

The invention relates to an electronically slip-controlled vehicle brake system according to the features of the preamble of claim 1. A vehicle brake system of this type is known, for example, from DE 102010042534 A1.

This vehicle brake system comprises two identically designed brake circuits having wheel brakes connected thereto. The brake circuits are connected to a main brake cylinder which can be actuated by a driver using muscular force. By way of the actuation of the main brake cylinder, a brake pressure is built up, which is fed to the wheel brakes via electronically controllable valves. Each brake circuit is equipped with a pressure-generating unit which, in the case of a traction control system (TCS operating state) or an electronic stability program (ESP operating state), is used for supplying the wheel brakes with pressurized brake fluid, independently of the driver, or which—within the scope of an antilock braking system (ABS operating state)—carries out an adaptation of the brake pressure to the slip conditions prevailing at the particular wheel. Conventional pressure generators are gear pumps or piston pumps.

Due to new system functions, a continuously increasing volume of brake fluid is required at the wheel brakes within continuously shorter times. In this context, mention is made, for example, of the pedestrian protection function, in which the vehicle must be braked to a stop within the shortest possible time.

Known pressure generators have, for this purpose, a volumetric displacement which is too low, and an increase in this volumetric displacement would directly result in an increase in the necessary drive power and, therefore, necessarily, in an increase in the size and weight of the drive motor required therefor. In addition, the voltage supply to the drive unit would also have to be adapted, in order to manage the higher amperages. In all, the costs of the vehicle brake system would increase considerably.

### Advantages of the Invention

By contrast, an electronically slip-controlled vehicle brake system according to the features of claim 1 has the advantage that its pressure-generating unit allows for a variable supply with pressure medium. This means that a pressure-generating unit according to the invention is now capable of delivering a volumetric flow rate of brake fluid which is adapted to the particular demand. A pressure-generating unit according to the invention comprises, for this purpose, at least two pumps for each brake circuit, wherein only one pump or both pumps jointly deliver brake fluid to the wheel brake, depending on the volume demand. The two pumps which are provided can be designed in such a way that they deliver identical or different volumetric displacements of brake fluid, which opens up an additional degree of freedom and further increases the flexibility of the pressure-generating unit according to the invention. In addition to the at least two pumps per brake circuit, according to the invention, electronically controllable means are provided, which control a pressure medium connection from a pressure line—into which both pumps deliver—to a suction line of at least one of the pumps. In the case of a passable pressure medium connection, one pump therefore pumps brake fluid only in the circuit, and therefore this pump does not contribute to the pressure medium delivery and can be driven using correspondingly less drive power.

A design of this type has the advantage that, at the beginning of a highly dynamic braking operation, i.e., when the pressure level is low and the volume demand is high, both of the pumps deliver, whereas, after a predefinable pressure threshold has been reached, the volume demand remaining until the final setpoint pressure is reached is low, but the pressure level has already increased and, therefore, the delivery volume of one of the pumps is sufficient. The total drive power to be applied by the pump drive is reduced and evened out in this way and drive units having less power can be utilized and can be designed to be more compact, lightweight, and inexpensive.

Further advantages or advantageous refinements of the invention result from the dependent claims and the following description.

A pressure-generating unit according to the invention is preferably equipped with a non-return valve which is situated between the pumps, on the particular pressure side of these pumps. As a result, the pump that is presently not contributing to the delivery quantity of the pressure-generating unit is prevented from working against the increased pressure level of the delivering pump and, therefore, is prevented from unnecessarily consuming drive energy. The non-return valve therefore improves the energy-related efficiency of the pressure-generating unit.

In the flow direction of the non-return valve, according to the invention, a controllable pressure medium connection, which connects the pressure side of one of the pumps to the suction side of at least one of the pumps, branches off upstream from this non-return valve. In order to control this pressure medium connection, electronically controllable means are provided, preferably pressure medium valves, which can be actuated by a magnetic actuator or by a piezoelectric actuator. Advantageously, these valves have a blocking position and a passage position and can assume any number of intermediate positions between these two positions, i.e., they are designed as proportional valves. This allows for a particularly sensitive adjustment of the pressure medium volume provided by the pressure-generating unit. Alternatively, it would also be possible to use switching valves which are switched from their blocking position into their passage positions and by means of which a regulation of the flow-through quantity takes place by adjustment of the cycle ratio of its electronic control.

### DRAWING

One exemplary embodiment of the invention is represented in the drawing and is described in greater detail in the following description. The sole figure shows the invention on the basis of a hydraulic circuit diagram which represents a brake circuit of a vehicle brake system according to the invention by means of circuit symbols.

### DESCRIPTION OF THE EXEMPLARY EMBODIMENT

In the sole figure, a single brake circuit of an electronically slip-controlled vehicle brake system is represented and is labeled with reference number 10. This brake circuit 10 is connected to a main brake cylinder 12, via which the driver can build up brake pressure using muscular force, for example, by actuating a pedal. Upstream from the main brake cylinder 12, a switching valve 14 controls a pressure medium connection of the main brake cylinder 12 to the wheel brakes 16 of the brake circuit 10. In the exemplary embodiment, the brake circuit 10 is equipped with two wheel brakes 16. Assigned to each individual wheel brake 16 is a pressure modulation device comprising an upstream pressure build-up valve 18 and a downstream pressure-reduction valve 20. Both valves 18, 20 can be switched by means of electronic control from a normal setting into a switched setting by a control signal calculated by a control unit 21. Pressure build-up valves 18 are passable in their home position and block in their switched position, while pressure-reduction valves 20 are closed in the home position and are passable in their switched position. Pressure medium flows via the pressure build-up valve 18 to the wheel brake 16 and effectuates a pressure build-up, whereas pressure medium flows out of the wheel brake 16 via the pressure-reduction valve 20, in order to reduce the pressure level at this wheel brake 16. Outflowing pressure medium enters a return line 24 which is equipped with a buffer storage 22 and ultimately leads to a suction connection of a pressure-generating unit withdraws the pressure medium from the buffer storage 22 and provides it, under higher pressure, to the pressure build-up valves 18, where it is then held in the wheel brake 16 for a subsequent pressure build-up. A line branch 34 connects the suction connection of the pressure-generating unit 30 to the main brake cylinder 12. This line branch 34 is controlled by a high-pressure switching valve 36 which is closed in its home position and is open in its switched position. When the main brake cylinder 12 is actuated, the pressure-generating unit 30 can withdraw pressure medium from this main brake cylinder 12 via the high-pressure switching valve 36 if the pressure medium volume stored in the return line 24 and in the buffer storage 22 is insufficient for increasing, according to demand, the brake pressure level at the wheel brake 16, which is set by the driver.

To this extent, the vehicle brake system described corresponds to the present prior art. By means of the electronic control unit 21 provided, the described components of the vehicle brake system can be controlled in such a way that the brake pressure at the wheel brakes 16 can be adapted to the slip conditions which presently prevail at the wheels of the vehicle assigned to these wheel brakes 16. This can take place with or without support by the driver, as described. By means of a vehicle brake system designed in this way, braking operations can therefore be carried out with a traction control system (TCS), with an antilock braking system (ABS), or with electronic stability control (ESP).

The vehicle brake system according to the invention differs from this prior art, inter alia, by the design of its pressure-generating unit 30. The latter comprises, according to the invention, at least two pumps 30a, 30b per brake circuit, which are driven by one shared drive motor 40. Both pumps 30a, 30b are connected on the pressure side to one shared pressure line 42. Located between the high-pressure outlets of the pumps 30a, 30b is a non-return valve 44 which prevents one of the pumps 30b from delivering against the pressure level of the other pump 30a. This non-return valve 44 comprises, for this purpose, a closing element 46 which is pressed against a valve seat 48 via the application of pressure, in order to close said valve seat as soon as the pressure level downstream from the valve seat 48 would become higher than upstream therefrom. A non-return valve spring is not necessarily required. Upstream from the non-return valve 44, as viewed in the flow direction of this non-return valve 44, a pressure medium connection 50 branches off from the shared pressure line 42 which is connected to the suction side of at least one of the pumps 30a, 30b, specifically to the suction sides of both pumps 30a, 30b in the exemplary embodiment. Electronically controllable means in the form of a valve, which is referred to in the following as a connection valve 52, are provided for controlling this pressure medium connection 50. This connection valve 52 is preferably a proportional valve which can be brought into any number of intermediate positions from a blocking position (home position) into a passage position. As the activation of the connection valve 52 increases, its passable cross section increases and the lesser the throttle effect is. In order to avoid a hydraulic short circuit when the connection valve 52 is completely opened, a throttle point is formed in the passage cross section of the connection valve 52, which becomes effective as soon as the connection valve 52 no longer assumes its blocking position.

In the vehicle brake system according to the invention, the volume of the supply with pressure medium can be controlled in a variable manner by means of a pressure-generating unit 30 designed in this way. This means that, depending on the demand of the particular braking operation, both of the pumps 30a, 30b deliver, e.g., due to a complete closure of the connection valve 52, and the pressure-generating unit 30 therefore provides its maximum delivery volume, while a complete opening of the pressure medium connection 50 results in only one of the two pumps 30a, 30b delivering pressure medium and the respective other pump 30b also running, but without pressure medium, or pumping its delivery volume in the circuit across the throttle point in the connection valve 52. In this state, the pressure-generating unit 30 therefore has its minimal delivery volume. By means of an adapted electronic control of the connection valve 52, any number of intermediate positions can be set in this way and, therefore, the delivery volume of the pressure-generating unit 30 can be flexibly adapted to the particular pressure medium demand of the vehicle brake system. A large delivery volume is necessary, for example, when the clearance up to the point at which the brake pads rest against their brake bodies must be overcome as quickly as possible at the beginning of an emergency braking operation. A small delivery volume is sufficient, however, in order to build up or modulate the ultimately required brake pressure starting at a pressure threshold which can be stored in the electronic control unit 21. In addition, the loading of the drive motor 40 of the pumps 30a, 30b is evened out when the pressure-generating unit 30 delivers by means of one or both of the pumps 30a, 30b according to demand. Conventional pump units 30 having only one pump and one drive motor must equally satisy the requirements with respect to volume and pressure, and therefore their structural design is disadvantageous in terms of their dimensions, the weight, the costs and, last but not least, the operating noise. With respect to the operating noise, it should be noted that a pressure-generating unit according to the invention also allows for an optimization of the foreseeable noise-damping measures in the case of a vehicle brake system by way of now allowing different types of pulsation-damping units to be utilized, the damping properties of which are optimized either with respect to a delivery of a large quantity of pressure medium or with respect to high operating pressures.

Further advantages or advantageous refinements of the invention are conceivable, of course, without departing from the fundamental idea of the invention, which was described.

1. An electronically slip-controlled vehicle brake system comprising:
one or more brake circuits;
at least one wheel brake connected to each of the one or more brake circuits; and
a respective drivable pressure-generating unit for each of the one or more brake circuits, the respective drivable pressure-generating unit configured to (i) supply the at least one wheel brake (4-6) connected to each brake circuit with pressure medium under a brake pressure or (ii) adapt the brake pressure to the slip conditions of a wheel assigned to the at least one wheel brake connected to each brake circuit, and the respective drivable pressure-generating unit including:
at least two pumps configured to deliver pressure medium into a shared pressure line, and
an electronically controllable mechanism configured to control a pressure medium connection from the shared pressure line to a suction side of at least one of the pumps depending on the as a function of a pressure medium volume demand of the at least one wheel brake connected to each brake circuit.

2. The electronically slip-controlled vehicle brake system as claimed in claim 1, wherein the respective drivable pressure-generating unit further includes:
a non-return valve positioned positioned between the at least two pumps on a pressure side of one of the at least two pumps.

3. The electronically slip-controlled vehicle brake system as claimed in claim 2, wherein the pressure medium connection, as viewed in a flow direction of the non-return valve, branches off from the pressure line upstream from the non-return valve.

4. The electronically slip-controlled vehicle brake system as claimed in claim 1, wherein the at least two pumps of the respective pressure-generating unit are configured to deliver different volumes of pressure medium.

5. The electronically slip-controlled vehicle brake system according to claim 1, wherein the electronically controllable mechanism has at least one valve which can be actuated by an actuator.

6. The electronically slip-controlled vehicle brake system as claimed in claim 5, wherein the electronically controllable mechanism is a proportional valve that is movable into a plurality of intermediate positions from a blocking position into a passage position.

7. The electronically slip-controlled vehicle brake system as claimed in claim 6, wherein the electronically controllable mechanism has a throttle point in thea flow cross section of the proportional valve.
